(19) United States
(12) Patent Application Publication
(10) Pub. No.: US 2015/0296324 A1
(43) Pub. Date: Oct. 15, 2015

(54) Method and Apparatus for Interacting Between Equipment and Mobile Devices

(71) Applicant: Mitsubishi Electric Research Laboratories, Inc., Cambridge, MA (US)

(72) Inventors: Tyler Garaas, Brookline, MA (US); Dirk Brinkman, Cambridge, MA (US)

(73) Assignee: Mitsubishi Electric Research Laboratories, Inc., Cambridge, MA (US)

(21) Appl. No.: 14/250,497

(22) Filed: Apr. 11, 2014

(51) Int. Cl. H04W 4/00; G08B 5/22; G06T 11/60

(52) U.S. Cl. CPC H04W 4/008; G06T 11/60; G08B 5/226; H04W 4/18

(57) ABSTRACT

A method interacts between equipment and a mobile device by first selecting, using the mobile device, the equipment. A communication link is established between the mobile device and the equipment. In response, data from the equipment is received in the mobile device then the equipment and mobile device interact according to the data, wherein the equipment is within a visible range of the mobile device.

### FIELD OF THE INVENTION

This invention relates generally to interacting with equipment using a mobile computing device, and more particularly to interacting using computer vision and augmented reality.

### BACKGROUND OF THE INVENTION

When a user wishes to interact with equipment using a mobile device, the capabilities and functions of that device may not be known ahead of time by the mobile device, which would limit the ability for the mobile device, and equipment to functionally interact. On the other hand, if the mobile device does know the capabilities of the equipment, the mobile device can readily generate the right commands and interpret the data received from the equipment. For the operations to be fast, the data needs to reside locally on the mobile device. However, it is unlikely that the data always exist on the device, given the innumerable varieties of equipment. In which case, the data need to be acquired from a source.

One possible source is a database server connected to the mobile device by a network. However, for some potential applications, such networks are not always available. This means that the user needs to know in advance every piece of equipment that the user intends to interact with in the future, and download the data ahead of time, assuming that the network is available and the mobile device is permitted to access the network, which, for security reasons, is not always the case.

In some applications, it would be useful to facilitate interactions between a mobile device and equipment by using computer vision (CV) techniques to overlay augmented reality (AR) content, such as graphics, on the device. In this application it is necessary that the device can recognize and/or segment the equipment in acquired images of the equipment based on sensory inputs from, e.g., a two-dimensional camera, a three-dimensional depth scanner, and the like. For the device to be able to perform such computer vision operations, certain data that uniquely identifies the equipment or its parts must exist. Often, the data are highly equipment specific and not easily decipherable by the user. Data to facilitate recognition by CV techniques and subsequent interaction can be achieved as described above, but this may be problematic for the described reasons.

Another potential source for the data required to enable successful CV/AR interaction is for the user to use the device to generate the data. This is also problematic as it is often difficult to acquire the data correctly using sensors of the device so that the interaction can be performed in a reliable manner, which can significantly increase cost and time. In fact, it is often necessary for an expert to perform the data generation. Furthermore, in that case, each device would contain a different copy of the data, which may lead to each devices behaving differently when performing the interaction.

Yet another method, is to place tags, e.g., quick response (QR) codes, on the equipment and its parts. Typically such tags only identify the equipment associated with the tags, which means that the tag is missing specific information about operational characteristics of the equipment. Entering the information manually into the device is time consuming. In addition, such tags can only be viewed accurately from certain angles and are prone to becoming torn or dirty so that the tags become unreadable.

### SUMMARY OF THE INVENTION

Modern facilities, such as factories, often contain many pieces of large advanced manufacturing equipment; NC milling machines, laser cutters, and robots, for example, are commonplace in today's factories. Maintenance engineers are required to ensure that the factory achieves as much up-time as possible, and their job would greatly benefit from the ability to interact with the equipment in an easy and intuitive manner; they may, for instance, wish to receive detailed machine diagnostic information, or manipulate the machine's actuators to a safe position.

One possible solution to enable such interaction is to supply each piece of industrial equipment with its own interface (i.e., display and input), but this significantly adds cost to each piece of equipment sold; furthermore, some pieces of equipment may be too small or hidden from direct view (e.g., programmable logic controllers). Now that mobile devices, such as tablets, smart phones, and augmented reality glasses, are ubiquitous, the engineer may be supplied with a generic mobile device of such a type that can interact with all pieces of equipment that they might service. However, there remains the problem of how the generic mobile device is able to interact with such a wide variety of equipment.

A tablet is a mobile computer with a display, circuitry, memory, and a battery in a single unit. The tablet can be equipped with sensors, including a camera, microphone, accelerometer and touch sensitive screen, as well as a wireless transceiver to communicate with the equipment and to access networks.

In order for successful interaction to take place, the mobile device may require specific knowledge of one or more of the following: machine functions and returnable, data, called and interpreted by an application programming interface (API); a displayable user-interface that allows the operator easily manipulate the machine or request specific data; descriptive data of the equipment that will allow the operator's device to identify the equipment from incoming sensor data. It is assumed that the equipment is within visible range al the user of the tablet and the camera to make the interaction effective.

One particularly useful application is to provide an interface or diagnostic data directly on top of a live image of the equipment. When a user wishes to interact with a piece of equipment or a machine using a mobile device, via computer vision (CV) and an augmented reality (AR) content, the mobile device needs a way to recognize the equipment, or parts of the equipment, and to extract a relative pose of the device with respect to the equipment. To do so, certain data need to exist on the device to enable the mobile device to interact with the equipment in a reliable manner.

Data to support CV and AR could be determined locally, but this can significantly increase the equipment setup time. In addition, the data can be inaccurate due to scanning techniques, changes in equipment settings, the environment, and many other factors. Alternatively, the data can be predetermined in a conventional manner with enhanced generality to adapt to environmental differences. The predetermined data, such as image descriptors for a set of poses and conditions, can come from a networked database, but this is not always possible, as wireless networks have security and reliability problems in industrial environments.

The embodiments of the invention overcome the limitations of prior art methods by storing the predetermined data on the equipment, and communicating the data to the mobile device via short-range communication technologies, such as near field communication (NFC), Bluetooth® or Fi™. Then, the user of the mobile device can interact with the equipment to transfer the predetermined data to the device. The mobile device can also include software that enables the user to interact with the equipment via the mobile device.

Such a system has many advantages. First, a variety of mobile devices can be used to interact with different equipment by specifying to the equipment the configuration and capabilities of the mobile device, to which the equipment responds with the correct adapted data for performing functional interaction with the equipment. Interaction in such a case can include operating various features of the machine, e.g., switching the machine on/off, manipulating an actuator, changing machine parameters, etc, or the interaction can involve receiving various important pieces of operating data from the equipment and displaying these to the user so that the user can monitor the activity of the equipment, e.g., progress in completing a specific task.

Yet another possibility for interaction is that the user connects the mobile device wirelessly to multiple pieces of equipment, retrieves interaction data from the multiple pieces of equipment, and uses the mobile device to coordinate the interaction between the device and the pieces of equipment, and between the pieces of equipment themselves, where the specific functions that specify interaction between the equipment conic from one or multiple pieces.

In some embodiments, the CV data can be generated by an expert, once for each sensor modality, which means minimal setup time and maximal accuracy and reliability for the user. As an advantage, the user does not need to know ahead of time what pieces of equipment the user will interact with. As another advantage, there is no need for additional equipment, other than the mobile device.

The interaction can be made secure by only storing the data received from the equipment in volatile memory and restricting the device to only receive data supplied by the equipment for a particular interaction.

### BRIEF DESCRIPTION OF THE DRAWINGS

FIG. 1 is a block diagram of equipment and a mobile device and according to embodiments of the invention;

FIG. 2 is a flow diagram of a method for interacting between the equipment and the mobile device of FIG. 1 according to embodiments of the invention;

FIG. 3 is a schematic of the mobile device displaying, an image of the equipment and machine specific graphic overlays sufficient for augmented reality to interact with the equipment; and

FIG. 4 is a schematic of a mobile device interacting with multiple pieces of equipment according to embodiments of the invention.

### DETAILED DESCRIPTION OF THE PREFERRED EMBODIMENTS

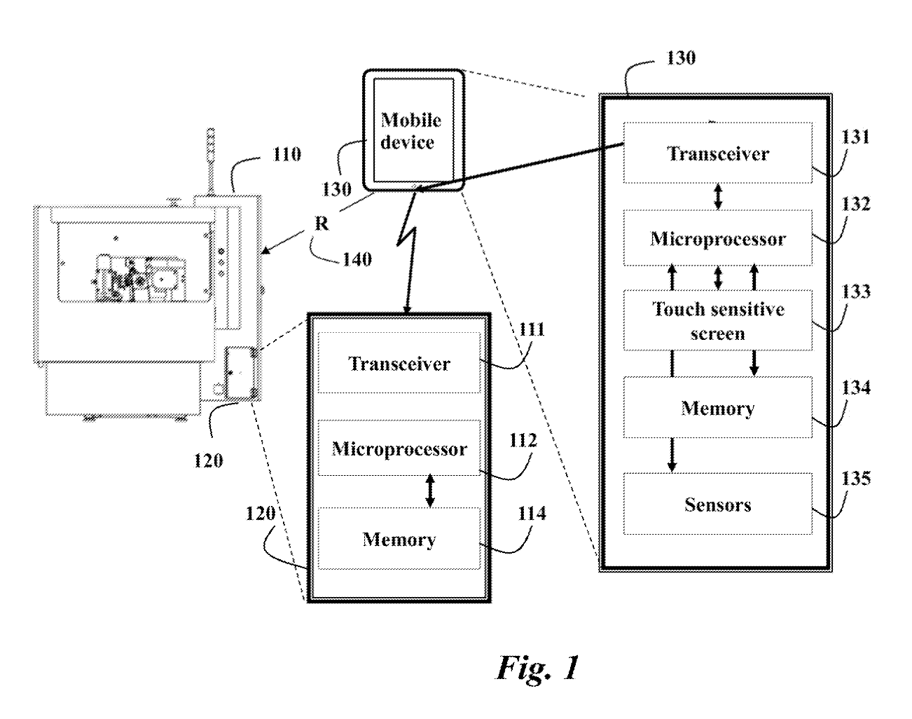

As shown in FIG. 1, the embodiments of the invention include equipment 110 and a mobile device 130 to interact with the equipment. The equipment includes a computerized interface 120. The interface includes a wireless transceiver 111, a microprocessor 112, and memory 114. The equipment can be, for example, a manufacturing machine, such a milling or drilling machine, a portion of a factory assembly line, or a robot, The transceiver can use near field communication (NFC), Bluetooth®, or another point-to-point communication technology. The microprocessor can be an Arduino® microcontroller with a secure digital (SD) card. The SD card is a non-volatile, memory for use in, portable devices, such as mobile phones, digital cameras, and tablet computers.

The mobile device 130 also includes a transceiver 131, a processor 132, a touch sensitive display 133, memory 134 (e.g., the SD memory card) and sensors 135, e.g., a camera, a microphone, and an accelerometer. In order to interact with equipment effectively and efficiently, the equipment is within a visible range 140 of the user of the tables, and the camera.

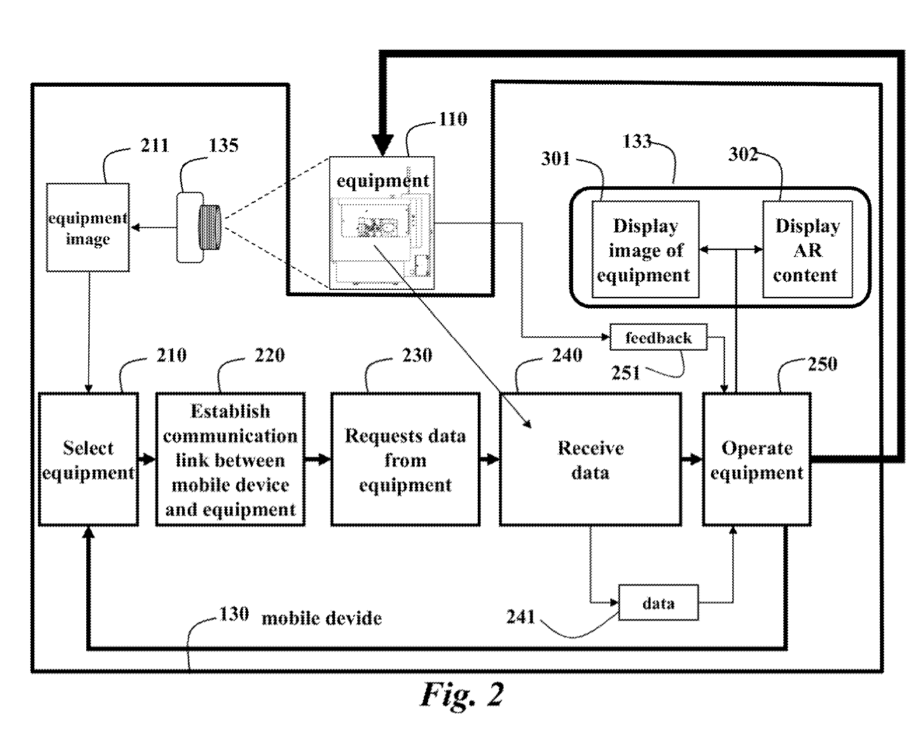

FIG. 2 shows the steps of a method for interacting between the equipment 110 and the mobile device 130 of FIG. 1. The mobile device is used to select 210 the equipment. One way to do this automatically is to acquire an image 211 of the equipment, and then use computer vision to identify the equipment. After the equipment is selected, a communication link, is established 220 between the equipment and the mobile device. The mobile device can use the link to request 230 data 241 from the equipment. In response to the request, the equipment transmits 240 the data to the mobile device.

In one embodiment, a manufacturer of equipment can supply a single “master” application (MAPP) for each potential mobile device. This MAPP contains all the necessary functionality to search for equipment built by the manufacturer with this type of capability, establish a connection, and request all the necessary data. It should be noted that the request of data may be implicit in the connection between the device and equipment. This data can comprise of many different pieces that are used to facilitate the interaction between the device and equipment, including CV data (e.g., image descriptors or 3D CAD models), AR overlays, application programmer interfaces (APIs), among others.

Then, the mobile device can be used operate 250 the equipment. Some of the data can be used for a generic controlling application. Other data can be equipment specific.

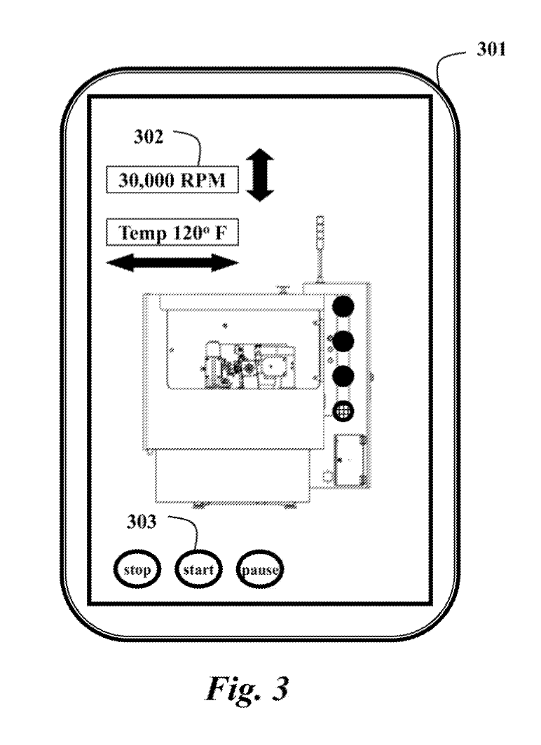

As shown in FIG. 3, during the operation of the equipment the mobile device can display all or part of the equipment 301. Augmented reality (AR) content 302 can also be displayed. The AR content can include virtual buttons 303 that control the equipment. The equipment can also feedback real time operating conditions, status, and the like, as part of the overlay graphics. If the equipment includes cameras, the user can observe in a sequence of images displayed on the mobile device, e.g., critical internal operations of the equipment, e.g., a milling tool, remotely, and operate the equipment accordingly.

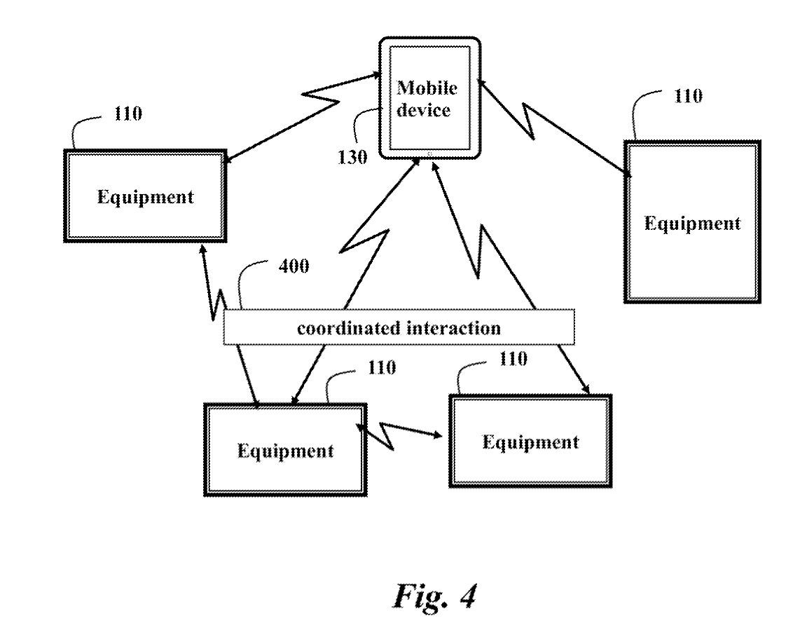

As shown in FIG. 4, in another embodiment, the user connects the mobile device wirelessly to multiple pieces of equipment, retrieves interaction data from the multiple pieces of equipment, and uses the mobile device to coordinate 400 the interaction between the device and the pieces of equipment, and between the pieces of equipment themselves, where the specific functions that specify interaction between the equipment come from one or multiple pieces of the equipment.

One potential scenario in which this type of application might be useful is for a CNC milling machine to signal, via the mobile device, to a mobile robot that the milling process is completed, and that the mobile robot, using CV and location data supplied via the mobile device, can locate and retrieve the finished workpiece.

Although the invention has been described by way of examples of preferred embodiments, it is to be understood that various other adaptations and modifications can be made within the spirit and scope of the invention. Therefore, it is the object of the appended claims to rover all such variations and modifications as come within the true spirit and scope of the invention.

Claimed is:

1. A method for interacting between equipment and a mobile device, comprising:
selecting, using the mobile device, the equipment;
establishing a communication link, between the mobile device and the equipment;
receiving data from the equipment in the mobile device; and
interacting between the equipment and mobile device according to the data, wherein the equipment is within a visible range of the mobile device and the steps are performed in a processor of the mobile device.

2. The method of claim 1, wherein the equipment is a manufacturing machine.

3. The method of claim 1, wherein the equipment is all or part of a factory assembly line.

4. The method of claim 1, wherein the equipment is a robot.

5. The method of claim 1, further comprising:
acquiring an image of the equipment with a camera arranged in the mobile device; and
selecting the equipment according to an identity of the equipment using computer vision.

6. The method of claim 1, where the data includes a master application (MAPP) for operating the equipment.

7. The method of claim 1, wherein the data includes an application programming interface (API).

9. The method of claim 1, wherein the data includes augmented reality (AR) content; and further comprising:
displaying the AR on the mobile device.

10. The method of claim 9, wherein the AR content includes virtual buttons for operating the equipment.

11. The method of claim 9, wherein the AR content includes real time operating conditions of the equipment.

12. The method of claim 1, wherein the data includes real time operating conditions of the equipment, and further comprising:
displaying the real time operating equipment on the mobile device.

13. The method of claim 1, wherein the data includes a sequence of images of all or part of the equipment, and further comprising:
displaying the sequence of images on the mobile device.

14. The method of claim 1, wherein the data are only stored in a volatile memory of the mobile device.

15. The method of claim 1, wherein the mobile equipment interacts with multiple pieces of equipment.

16. The method of claim 1, further comprising:
specifying, by the mobile device, to the equipment a configuration and capabilities of the mobile device; and
adapting the data to the configuration and capabilities of the mobile device.

17. A system for interacting between equipment and a mobile device, wherein the equipment comprises:
a wireless transceiver;
a non-volatile memory configured to store data related to the equipment;
a microprocessor; and
wherein the mobile device comprises:
a wireless transceiver;
a volatile configured to store the data;
a touch sensitive screen;
a sensor; and
a processor, wherein the processor, during the interacting, selects the equipment, establishes a communication link between the mobile device and the equipment, receives data from the equipment, and interacts between the equipment and mobile device according to the data.

18. The system of claim 17, wherein the equipment is a manufacturing machine.

19. The system of claim 17, wherein the mobile device further comprises:
a sensor configured to acquire an image of the equipment, and wherein the processor selects the equipment according to an identity of the equipment using computer vision.

20. The system of claim 17, wherein the AR content includes real time operating conditions of the equipment.
